(19) United States
(12) Patent Application Publication
(10) Pub. No.: US 2006/0190352 A1
(43) Pub. Date: Aug. 24, 2006

(54) Method for providing history data to sellers about internet auction and marketplaces

(76) Inventor: Robert Marc Zeidman, Cupertino, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/408,490

(22) Filed: Apr. 21, 2006

Related U.S. Application Data
(62) Division of application No. 09/972,264, filed on Oct. 9, 2001.

(51) Int. Cl. G06Q 30/00

(52) U.S. Cl. 705/26

(57) ABSTRACT

The present invention provides a method and apparatus to allow sellers at online auctions to optimize the way they sell items and get the best possible price for the items. The invention provides a method for searching a database for data on previous sales of similar items at online auction websites. The data can then be summarized and graphed. Using this data, the seller can make his own conclusions about the best way to sell his item, or he can get a recommendation from the invention about the best way to sell the item. If data about similar items are not available in the database, the invention allows the seller to start an agent program that will search various auction sites for the data over a period of time.

### BACKGROUND OF THE INVENTION

With the explosive growth of the Internet as a worldwide communications medium, e-commerce (buying and selling items over the Internet) has become increasingly popular. One particular form of e-commerce, online auctions, has seen phenomenal growth, even in difficult economic times, due to its advantage of being able to put buyers and sellers together directly with little cost. Transactions that could not have taken place only several years ago, with buyers and sellers separated by large distances, are taking place daily. One outgrowth of online auctions is that small “Mom and Pop” businesses without large inventories are now springing up to sell items on online auction sites. Online auctions enable these sellers because overhead expenses such as marketing, advertising, shipping, and distribution can be reduced. Online auctions also allow business with very small inventories to sell items at a profit.

The method of this patent allows companies and individuals that wish to sell items on an online auction, to gather data about previous purchases that will enable them to optimize the placement, presentation, minimum price, and other parameters about the items for sale, in order to maximize the sale price and thus their profits.

### SUMMARY OF THE INVENTION

The present invention allows sellers at online auctions to gather data about items that they are preparing to offer for sale. The invention provides a method for a Web server computer to gather data about sales at online auction websites using what are called “spiders” or “agents.” These agents actively access the online auction websites and search for various items on the site, acting as a potential buyer of these items. These agents also collect data on these items after the items are sold, if that information is still available at the online auction websites. The agents take the data that is found for each item and stores the data in a database in the Web server computer.

The invention also provides a method for a seller to specify information about a product for sale including its name, its general category, its manufacturer, its condition, its size, its color, its age, its model, and its model number. The seller enters this information into his computer, which then sends the information over the Internet to the Web server computer. The Web server computer then examines its database of items that have already been sold at various online auction websites and sends this data back to the seller via the Internet, where the seller computer displays the data to the seller in a user-friendly, readable manner. The data can be manipulated by the seller to show comparisons and statistics, such as which online auction websites produced the highest final price for this type of item, which month had the highest sales of this type of item, and comparisons of the amount of text and graphics on the Web page announcements that were most successful in selling these types of items.

It is possible that the item which about which the seller needs data has not yet been searched by the agents, and thus data about the item is not present in the database. The invention also provides a method for the Web server computer to initiate an agent for the purpose of searching for information about a particular item at the request of the seller. In this case, the seller can set such search parameters such as the item's name, its general category, its manufacturer, its condition, its size, its color, its age, its model, and its model number. The seller can also set such parameters for the agent as the length of time to perform the search and accumulate data, the number of online auction sites to search, particular online auction sites to search, the amount of data to store in the database, and other parameters as may be appropriate.

### BRIEF DESCRIPTION OF THE DRAWINGS

FIG. 1 shows a seller's computer connected, via the Internet, to a Web server computer in accordance with the present invention.

FIG. 2 shows a Web server computer connected, via the Internet to two auction website Web server computers in accordance with the present invention.

FIG. 3 shows an application server program connected to a seller computer and an online auction website Web server computer in accordance with the present invention.

FIG. 4 shows a flowchart of a process, in one embodiment of the present invention, which provides data about items from online auction websites to users.

FIG. 5 shows a flowchart of a process, in one embodiment of the present invention, in which an agent collects data about items from online auction websites.

FIG. 6 shows a graphical Web browser user interface, in one embodiment of the present invention, for enabling a seller to enter information for initiating an agent to search for a particular item.

FIG. 7 shows a graphical Web browser user interface, in one embodiment of the present invention, for presenting a seller with information that has been gathered about previous sales of similar items.

FIG. 8 shows a graphical Web browser user interface, in one embodiment of the present invention, for presenting a comparison of different factors affecting the final sale price of an item on an auction site.

FIG. 9 shows a graphical Web browser user interface, in one embodiment of the present invention, for presenting a graph comparing various factors for each item sold on an auction site.

FIG. 10 shows a graphics Web browser user interface, in one embodiment of the present invention, for presenting a recommendation for selling an item on an auction site.

FIG. 11 shows a graphics Web browser user interface, in one embodiment of the present invention, for configuring an agent to search auction websites for information about similar items for sale.

### DETAILED DESCRIPTION

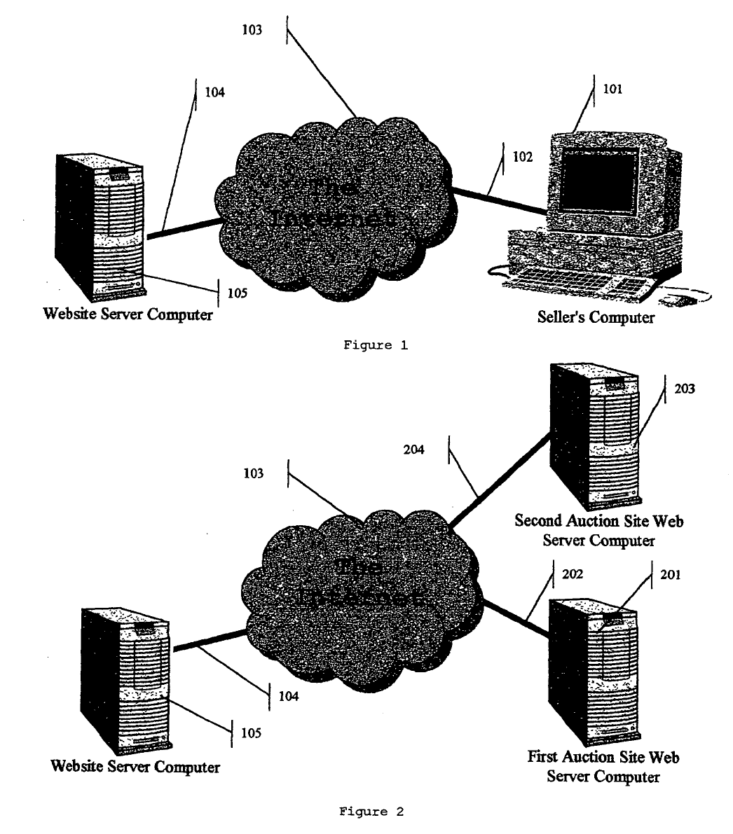

The present invention is illustrated in FIG. 1 and FIG. 2. FIG. 1 shows one configuration where a seller's computer 101 is connected to the Internet 103 via an Internet connection 102 such as a phone line or a cable service. A website server computer 105 is also connected to the Internet 103 via an Internet connection 104 such as a phone line, a cable service, or any other suitable method of internet access.

The seller uses a standard Web browser to send data and to receive data between the website server 105 and his computer 101. The seller specifies an item he has for sale and describes the item's characteristics by filling out a form on the website. The seller sends the data to the website server computer 105 via the Internet 103. The website server 105 receives the user's request for data and searches its database. If the results are in its database, the results are formatted for easy viewing and understanding, and the results are sent back to the seller's computer 101 via the Internet 103. The results are then viewed on the web browser of the seller's computer 101.

If website server computer 105 cannot find the results in its database, website server runs a program called an agent which searches auction websites via the Internet 103 using the connections illustrated in FIG. 2. Also, an agent can be run at regular intervals by the website server computer 105 even if a seller has not specifically requested it. By periodically running the agents, the database is kept current.

In FIG. 2, Website server computer 105 connects to the Internet 103 using an Internet connection 104 such as a phone line, a cable service, or any other suitable access method. In addition, auction sites are connected to the Internet as shown. First auction web server computer 201 and second auction web server computer 203 are also each connected to the Internet 103 using an Internet connection 202 such as a phone line, a cable service, or any other suitable access method. The agent software on the website server computer 105 connects to first auction site web server 201, acting as a buyer of a specific item, and requests information on items that have already been sold that are similar to the item. The information that is retrieved is sent back to the web server computer 105 where it is put into the database of web server computer 105. The agent then connects to second auction site web server 203 to again act as a buyer of a specific item and to request information on items that have already been sold that are similar to the item. The information that is retrieved is sent back to the web server computer 105 where it is put into the database of web server computer 105. This process continues until a number of auction sites have been visited and information on similar items has been received. The number of auction sites searched can be specified either by the seller, if the seller initiates the agent, or by the website server computer 105, if the website server computer 105 initiates the agent.

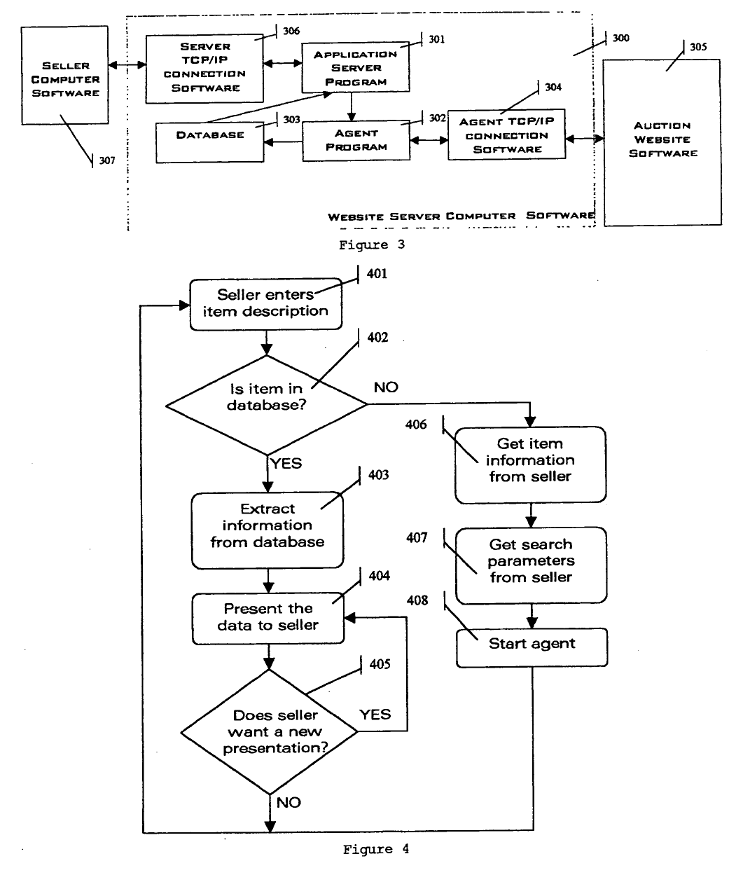

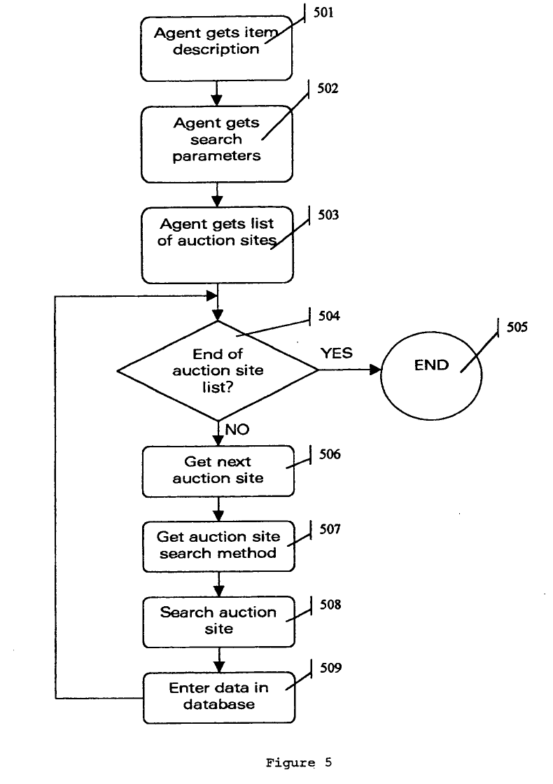

FIG. 3 illustrates software 300 running on the website server computer 105, according to one embodiment of the present invention. The software 300 communicates with the seller computer software 307, which in this embodiment is a web browser program for sending and receiving data. The software 300 also communicates with auction website software 305 in order to send requests to the auction website and retrieve data about items that have been sold. In practice the website server software 300 will communicate with many auction websites, but solely for the purpose of simplifying this description, only one website is shown in FIG. 3.

In this embodiment, the website server software 300 includes standard TCP/IP connection software 306 for communicating over the Internet with the seller computer software 307. Also, the website server software 300 includes standard TCP/IP connection software 304 for communicating over the Internet with the auction computer software 305.

The application server software 301 controls communication with the seller computer software 307 using TCP/IP connection software 306 to access computer software 307 via the Internet. Upon the seller's request, the application server software also retrieves data from the database 303 to send to the seller computer software 307. When the seller requests that an agent search auction sites and collect data on a specific item, or when the application server software 301 decides to collect data on a specific item, the application server software 301 causes an agent program 302 to run. The agent program 302 uses TCP/IP connection software 304 to connect to the auction website server software 305 via the Internet. The agent then requests information from the auction site server software 305 about items similar to the item. Agent software 304 receives data on the similar items and stores the data in database 305.

FIG. 4 shows a flowchart for the application software 301 that resides on the website server computer 105. First, the seller enters a description of the item he has for sale, shown in block 401. Next the application software determines whether data for this item is in the database. If the application software finds the requested data, execution continues to block 403. Otherwise, execution continues to block 407.

At block 403, the data about this item, or similar items, is extracted from the database. Execution continues to block 404 where the data is put into a format for easy viewing by the seller. Next, block 405 is executed, which checks whether or not the user would like the data, or parts of the data, to be put into a different format such as a chart or table. If a different format is not desired, execution loops back to block 401 where the application program waits for another request from the seller. Otherwise, execution loops back to block 404 where the data is presented to the user in the format requested.

In block 406, the application program gets a detailed description of the item from the seller. The detailed description may be the description entered in block 401 or it may include further information that is needed to accurately search the auction websites. Execution then continues to block 407 where the seller enters parameters to be used for the agent software, such as how long to run the agent, how many auction websites to search, which specific websites to search, or how many items to collect data on. Execution continues to block 408, which starts the execution of the agent software. Execution then loops back to block 401 where the application program waits for another request from the seller.

FIG. 5 shows one embodiment of a flowchart for execution of the agent software. Execution begins in block 501 where the agent software gets a description of the item for sale. Execution continues to block 502 where the agent gets a list of search parameters, such as how long to run the agent, how many auction websites to search how many items to collect data on. Execution then continues to block 503 where the agent is given a list of auction sites to search. Execution then continues to block 504 where the agent determines whether each auction site in the list of auction sites has been searched. If the specified auction sites are all searched, execution continues to block 505 where the agent software terminates. Otherwise, execution continues to block 506 where the agent finds the next auction site on the list to be searched. Execution then continues to block 507 where the agent determines the method for searching the next auction site in the list. Because each auction site presents different data and different formats to the web browser, each particular auction website must be searched using a different method. For example, different auction websites use different categories for the items that are being sold. Also, each auction website uses a different sequence of forms for the user to fill out to request data. In block 507, the agent determines the appropriate method for searching the particular auction website in the list.

Execution then continues to block 508 where the agent uses the method determined in block 507 to search the auction site. Execution then continues to block 509 where the agent takes the data that it has received from the auction website and stores it in the database. Execution then loops back to block 504 where the agent again determines whether it has searched each auction site in the list.

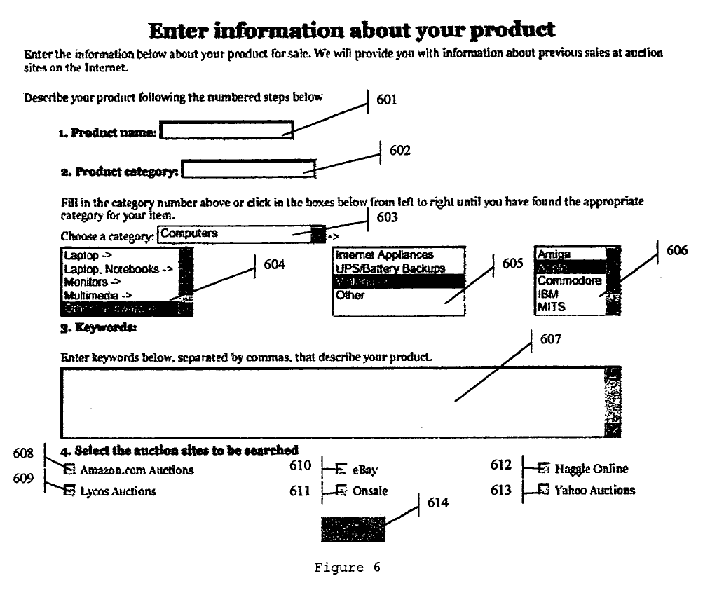

FIG. 6 shows a graphical user interface for allowing the seller to enter information about the item for sale in one embodiment of the present invention. The seller enters the item name in text box 601. The seller enters a category number for the item in text box 602 if he knows it. Otherwise the seller selects a general category from pull-down box 603. By selecting a general category in pull-down box 603, a list of sub-categories appears in list box 604. The seller then selects a subcategory from list box 604. If there are further subcategories of this subcategory, they appear in list box 605. The seller then selects a further subcategory from list box 605. If there are still further subcategories, they appear in list box 606. The seller then selects a further subcategory from list box 606. If there are still further subcategories, new list boxes will appear until the lowest subcategory is selected. Once the lowest subcategory is selected, the category number for the lowest subcategory will appear in textbox 602.

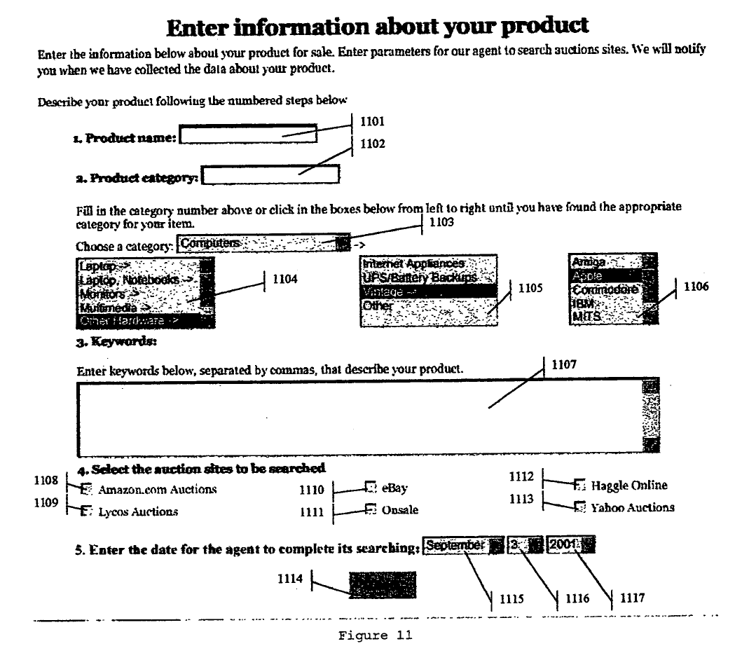

The seller can then enter keywords that describe important features of the item for sale into text box 607. In the next step, the seller checks all of the auction sites for which he desires information about similar items for sale. In this embodiment, any combination of auction sites, such as Amazon.com Auctions 608, eBay 610, Haggle online 612, Lycos Auctions 609, Onsale 611, and Yahoo Auctions 613, can be specified. To begin searching the database for information on similar items for sale, the seller clicks on the submit button 614. If similar items are not found in the database, or if the seller requires more current information, the seller is asked whether he wishes to have an agent search for the item. If the seller decides to have an agent search the sites, in this embodiment he is presented with the graphical user interface shown in FIG. 11 and which is discussed later.

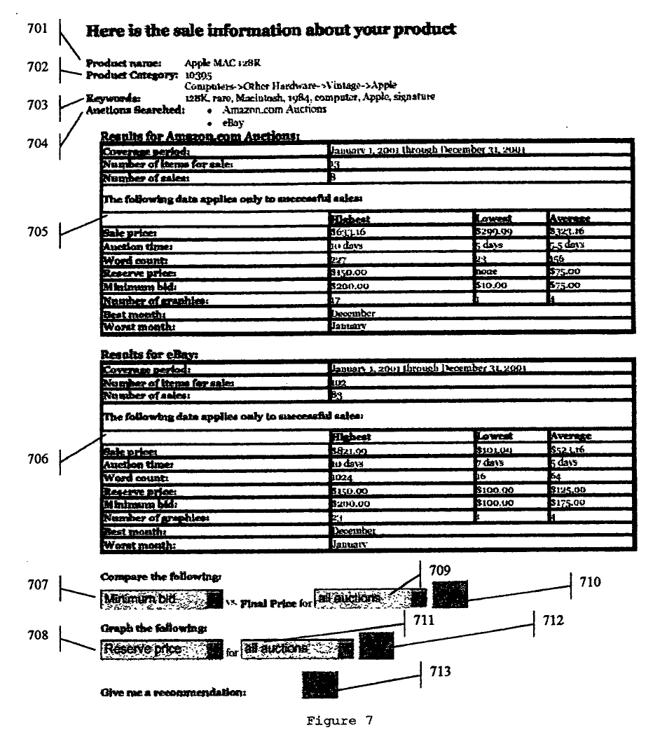

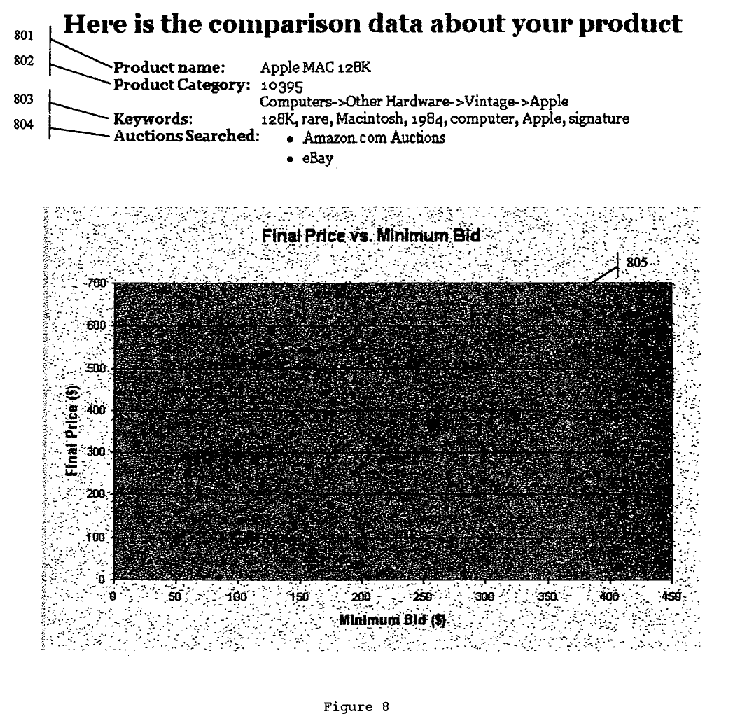

FIG. 7 shows a graphical user interface, according to one embodiment of the invention, for presenting information about similar items that have been sold at auction sites. This information is retrieved from the database. The information describes the item 701, the category for this item 702, the keywords 703 that were used to select these items from the database, and the auctions 704 that were searched for the data about these items.

In this embodiment, tables are presented to the seller for each auction site from which data has been retrieved and stored in the database. In this embodiment, table 705 is presented from auction site Amazon.com and table 706 is presented from auction site eBay. Each table shows the period of time that the auction site was searched and the number of items that were found for sale. Each table also presents the highest, lowest, and average values for the sale price, the auction length of time, the word count for the web page for each item, the reserve price for each item, the minimum bids for each item, and the number of graphics for the web page for each item. Each table also presents the best month and worst month for a sale. Other embodiments may present other information to the seller.

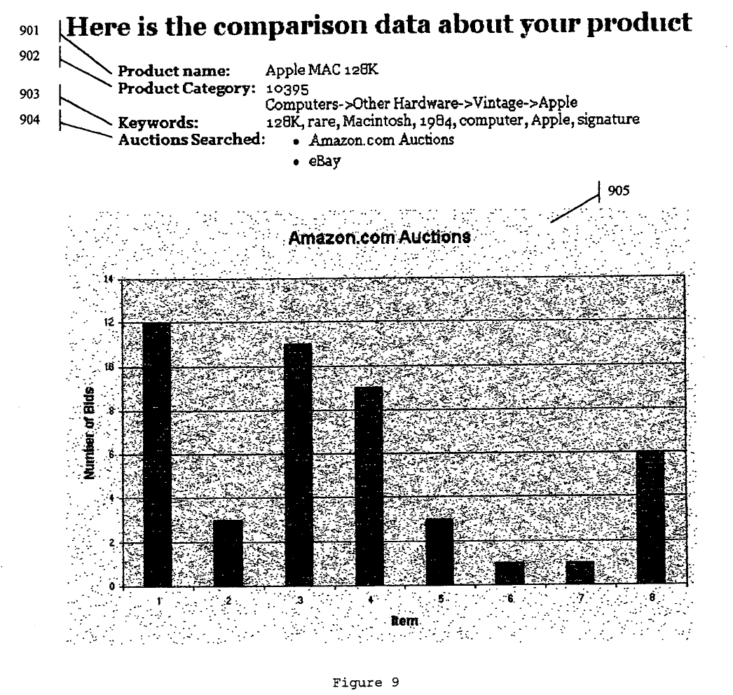

The information can also be compared and organized according to parameters set by the seller. In this embodiment, the seller may select several of the factors in list box 707 to be compared against the final price. The graph may be for a specific auction site or all auction sites depending upon the selection that the seller makes from list box 709. The comparison is generated when the seller clicks on submit button 710. One embodiment of the comparison that is generated is shown in a graphical user interface in FIG. 8, discussed later in this document.

In this embodiment, the seller may select several of the factors in list box 708 to be graphed. The graph may be for a specific auction site or all auction sites depending upon the selection that the seller makes from list box 711. The graph is generated when the seller clicks on submit button 712. One embodiment of the graph that is generated is shown in a graphical user interface in FIG. 9, discussed later in this document.

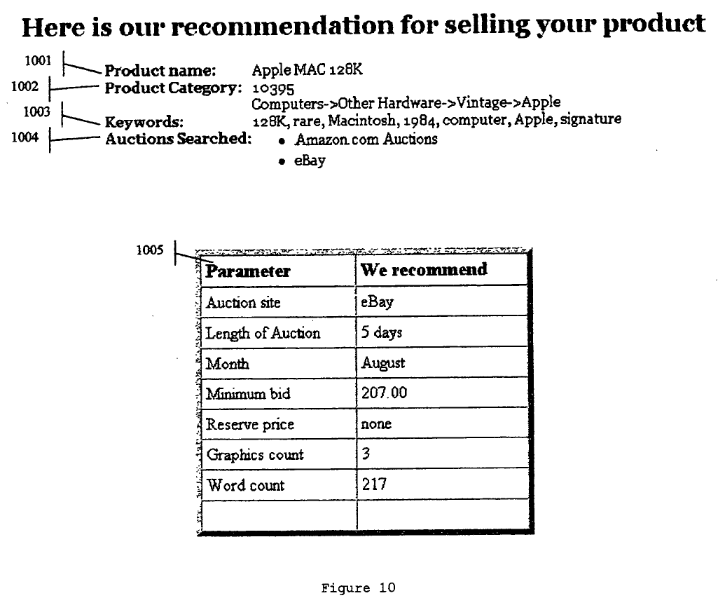

In this embodiment, the seller may ask for a recommendation to be given about the best circumstances in which to sell his item. This recommendation is generated when the seller clicks on submit button 713. One embodiment of the recommendation that is generated is shown in a graphical user interface in FIG. 10, discussed later in this description.

FIG. 8 shows one example of a comparison that can be generated from the data in the database, when the seller selects two different factors to compare. In the example, the seller has selected minimum bid to be compared against the final price for similar items sold in the past on one or more auction sites. Other factors can also be graphed against the final price. The graphical user interface shows the item name 801, the item category 802, the keywords 803 used to select similar items from the database, and the auctions 804 selected for the comparison. The chart 805 compares all examples of minimum bid in dollars to all examples of final price in dollars that are found in the database and match the criteria at the top for category 802, keywords 803, and auction sites 804.

FIG. 9 shows one example of a graph that can be generated from the data in the database, when the seller selects one factor to graph for each similar item in the database. In the example, the seller has selected the number of bids to be graphed for similar items sold in the past on one or more auction sites. Other factors can also be graphed. The graphical user interface shows the item name 901, the item category 902, the keywords 903 used to select similar items from the database, and the auctions 904 selected for the comparison. The chart 905 compares all examples of minimum bid in dollars to all examples of final price in dollars that are found in the database and match the criteria at the top for category 902, keywords 903, and auction sites 904.

FIG. 10 shows an example of a recommendation that can be generated for a seller based on data in the database about similar items that have already been sold. In the example, the graphical user interface shows the item name 1001, the item category 1002, the keywords 1003 used to select similar items from the database, and the auctions 1004 selected for the recommendation. Table 1005 shows the recommendation for the seller that, according to the information in the database, will produce the highest final price for the item. In the example, the highest price will be obtained if the seller offers the item on auction site eBay, with an auction length of 5 days, in the month of August, with a minimum bid of $207.00, with no reserve price. The web page that announces the item for sale should have 3 graphics and 217 words, in this example.

FIG. 11 shows a graphical user interface, in one embodiment of the present invention, for allowing the seller to initiate an agent to search for information on auctions sites for similar items that have already sold. The seller enters the item name in text box 1101. The seller enters a category number for the item in text box 1102 if he knows it. Otherwise, the seller selects a general category from pull-down box 1103. By selecting a general category in pull-down box 1103, a list of sub-categories appears in list box 1104. The seller then selects a subcategory from list box 1104. If there are further subcategories of this subcategory, they appear in list box 1105. The seller then selects a further subcategory from list box 1105. If there are still further subcategories, they appear in list box 1106. The seller then selects a further subcategory from list box 1106. If there are still further subcategories, new list boxes will appear until the lowest subcategory is selected. Once the lowest subcategory is selected, the category number for the lowest subcategory will appear in textbox 1102.

The seller can then enter keywords that describe important features of the item for sale into text box 1107. In the next step, the seller checks all of the auction sites for which he desires information about similar items for sale. In this embodiment, any combination of the auction sites, such as Amazon.com Auctions 110B, eBay 1110, Haggle Online 1112, Lycos Auctions 1109, Onsale 1111, and Yahoo Auctions 1113, can be specified. The user then specifies the ending date for the agent to stop searching auction sites for similar items that have already been sold, be entering an ending month in list box 1115, an ending date in list box 1116, and an ending year in list box 1117. The agent begins searching the auction sites at regular intervals, starting when the seller clicks on submit button 1114. The agent stops searching the auction sites on the date specified in list boxes 1115, 1116, and 1117.

The above detailed description is provided to illustrate specific embodiments of the present invention and is not intended to be limiting. Numerous variations and modifications are possible within the scope of the invention. The present invention is set forth in the appended claims.

1-6. (canceled)

7. A method for allowing a seller of items to gather data from e-commerce websites, comprising:
a. accepting a description from said seller about said items for sale,
b. examining a database for information gathered by data gathering software visiting said e-commerce websites about items similar to said items for sale that have previously been sold at said e-commerce websites,
c. extracting said information from said database, and
d. presenting said information to said seller.

8. The method of claim 7 further comprising
a. querying said user for a format in which said information is to be presented and
b. presenting said information in accordance with said format.

9. A method for allowing a seller of items to gather data from e-commerce websites, comprising:
a. accepting a description from said seller about said items for sale,
b. examining a database for information about items similar to said items for sale that have previously been sold at e-commerce websites,
c. upon determining that said database does not contain information about said similar items,
starting agent software to search e-commerce websites to gather information about said similar items that have previously been sold at said e-commerce websites, and
d. storing said information that has been gathered by said agent software into said database.

10. A method for updating a database with data from e-commerce websites about the sale of various items, comprising:
a. starting agent software at regular time intervals to search e-commerce websites to gather information about said various items that have previously been sold at said e-commerce websites and
b. storing said information into said database.

11. A method for updating a database with data from e-commerce websites about the sale of various items, comprising:
a. providing a description of an item,
b. providing a set of search parameters,
c. providing a list of e-commerce sites,
d. searching e-commerce sites on said list of e-commerce sites for said item according to said search parameters and said description, and
e. storing said information into said database.
